(19) United States
(12) Patent Application Publication
(10) Pub. No.: US 2003/0068186 A1
(43) Pub. Date: Apr. 10, 2003

(54) Split open, movably attached,closure that activates functions

(75) Inventor: Bradford T. Sorensen, Mahhattan Beach, CA (US)

Correspondence Address: JOHN PARKS, PARKS PRODUCTS, 3611 CAHUENGA, HOLLYWOOD, CA, 90068, US

(73) Assignee: Bradford Sorenson to Parks Products, Inc

(21) Appl. No.: 09/970,862

(22) Filed: Oct. 5, 2001

(51) Int. Cl. B26B 19/00

(52) U.S. Cl. 401/59; 220/345.5; 30/29.5

(57) ABSTRACT

A container having an inner volume and an outer surface having symmetrical arched track pairs on opposite sides of the container extending from an intersection at the top of the product function orifice to the bottom of the flattened support base of the container joined with a matched pair of half hollow, arching, combination split cap and handle components arched to match and slidably engage the arched track pairs on opposite sides of the container in order to form a product container, cap and handle combination that operate together when placed in the palm, fingers and thumb of a human being to slidably open and close with alternating hand grip pressure on the base or the top of the combination split cap and handles which may also automatically activate and deactivate the product function of one of the variety of products that could be located inside this type of container.

### BACKGROUND

This invention relates to improvements in closures of products having a closure that is permanently attached to prevent misplacement when open.

More specifically, the present invention relates to an innovation in the way closures open and close without the separation of the cap from the container.

Additionally, in a variety of applications, the movement of the closure activates the function of the product. Some applications include the actuation of a switch that opens or closes an electric circuit in order to operate a motor, light a bulb, spin a fan, dispense a liquid, vibrate, play music, display information, provide communication or other electronic function. Some other applications include the actuation of a pump to perform the multiple functions of squeezing and/or measuring an amount of the contents of the container out as the closure is opened and/or suctioning the contents of the container in when the closure is closed. Some other applications include the protection or the exposure of key pads, buttons, levers or switches related to the function of the contents of the container.

### BRIEF HISTORY

Containers with caps that are attached to prevent misplacement are well known in the previous art. Examples of such caps include tethered gas caps for automotive gas tanks or beer bottles with wire cam locks that retain the connection between the beer bottle and the cap or toy squirt gun water tank caps that have a T shaped tether that prevents separation of the toy and the cap or shampoo bottle caps with living hinge cap connectors.

The present invention introduces the unique concept of bisecting the cap into a pair of slidable, openable, shiftable, sealable, resealable, closure components that cooperate in combination with the container to provide the multifunctions of automatic activation of product function upon opening, single-handed open and close functions, automatic protective enclosure, resealable orifice, product switch actuator and/or product pump actuator and/or product display actuator, open product length expander, closed product length compactor, ergonomic grip handles in the closed, sliding transition and open positions and automatic closure and function deactivation when the flat support base is properly placed on a surface after use.

### SUMMARY OF THE INVENTION

A container having an inner volume and an outer surface having symmetrical arched track pairs on opposite sides of the container extending from an intersection at the top of the product function orifice to the bottom of the flattened support base of the container joined with a matched pair of half hollow, arching, combination split cap and handle components arched to match and slidably engage the arched track pairs on opposite sides of the container in order to form a product container, cap and handle combination that operate together when placed in the palm, fingers and thumb of a human being to slidably open and close with alternating hand grip pressure on the base or the top of the combination split cap and handles which may automatically activate and deactivate the product function of one of the variety of products that could be located inside this type of container.

The preferred embodiment of this invention is intended to fit in the palm of the human hand. Other sizes of the present invention are obviously an extension of the original idea.

The present container/cap/handgrip invention makes it possible to open the container while activating the product function, use the product function, deactivating the product function while closing the container with a minimal movement of a single human hand performing all the operations with a single hand grip location.

A squeeze at the base of the closed product container/cap/handgrip combination automatically opens the container, elongates the length of the container and closes an electrical circuit or activates a product function.

A squeeze at the top of the open product container/cap/handgrip combination automatically closes the container, collapses the length of the container and opens an electrical circuit or deactivates a product function.

### GENERAL DESCRIPTION OF THE INVENTION FUNCTION

The present invention utilizes a split cap and handle combination which is mounted on tracks to slidably guide the closure into an open and closed position. As the split cap is opened and closed, the function of the product enclosed within the container and/or the handles is activated or deactivated.

The preferred embodiment of the first application of the present invention is the containment of all of the functional components of a battery powered, electric motor driven, hair trimmer within the container and the combination split cap and handles creating a one hand operable automatic activating and deactivating product as it is opened and closed where the cap is permanently blended with the handle and slidably connected to the container so it will never be misplaced. When the preferred embodiment of the first application hair trimmer is placed upright on its flat support base, the electronic switch is automatically deactivated and the trimmer motor stops.

Another application of the present invention function occurs when the motion of sliding the split cap handles along the tracks on the container causes a pump to be activated to dispense a measured amount of the contents of the container out as the closure is opened and/or suctioning the contents of the container in when the closure is closed.

Another application of the present invention function occurs when the motion of sliding the split cap handles along the tracks on the container causes a knife blade within the container to be moved from an interior containment area to an exterior use area caused by the squeeze of the base split cap handles within the hand of the user. After a safety button is activated, a squeeze on the upper portion of the split cap handles within the hand of the user slides the knife back inside the protective container and closes the integrated cap.

Another application of the present invention function occurs when the motion of sliding the split cap handles along the tracks on the container causes a light bulb to be illuminated to create a flashlight function.

Another application of the present invention function occurs when the motion of sliding the split cap handles along the tracks on the container causes a battery contact to close causing a motor to spin a fan which causes the function of moving air.

Another application of the present invention function occurs when the motion of sliding the split cap handles along the tracks on the container causes a battery contact to close causing a motor to spin an eccentric weight which causes the function of vibration.

Another application of the present invention function occurs when the motion of sliding the split cap handles along the tracks on the container causes a battery contact to close causing a radio, media player or recorder to play music.

Another application of the present invention function occurs when the motion of sliding the split cap handles along the tracks on the container causes a battery contact to close causing a computer or electronic device to display information.

Another application of the present invention function occurs when the motion of sliding the split cap handles along the tracks on the container causes a battery contact to close causing a telephone, internet, computer, radio, pager or electronic device to provide the function of communication.

Another application of the present invention function occurs when the motion of sliding the split cap handles along the tracks on the container causes a battery contact to close causing the exposure of key pads, buttons, levers or switches related to the remote control of the function of other products

Other applications of the present invention will become self evident with the passing of time and the introduction of new technologies to be placed inside this type of container. Although the present invention has been described in terms of specific embodiments, it is anticipated that alterations and modifications thereof will no doubt become apparent to those skilled in the art. It is therefore intended that the teachings and drawings that comprise the content of this patent application as well as the following claims be interpreted as covering all such alterations and modifications as fall within the true spirit and scope of the teachings and drawings contained herein as well as the true spirit and scope of the invention claims and the invention itself.

### OBJECTIVES OF THE PRESENT INVENTION

The first objective of the present invention is to provide activation and deactivation of product functions related to the opening and closure of the product container to add convenience and multifunctions to the single action of gripping the product.

The second objective of the present invention is to combine the functions of a cap and a handle so that the cap is actually never separated form the container in its open, transitioning and closed positions so that the cap is never misplaced.

The third objective of the present invention is to create a product container that is expanded and/or elongated when open for access to the product functions and is collapsed or shortened in size when closed for transport and storage.

The fourth objective of the present invention is to provide a container and cap combination that opens, activates, performs its function, deactivates and closes while griped in one hand without changing the grip position or other outside input.

The fifth objective of the present invention is to create a product that once placed in the palm of one hand and wrapped up in the fingers and thumb, the functions of opening, activating, performing its functions, deactivating and closing can be performed by alternating hand grip pressure on various portions of the product cap/handle combination.

The sixth objective of the present invention is to provide a product that automatically closes, deactivates and reduces in size when placed upright on its flat support base.

The seventh objective of the present invention is to protect or expose the functional aspects of a products such as trimmers, keypads, pumps, blades, levers, lights, contacts, connectors, appliances, motors, keys or other functional items with a minimum of hand movement.

### REFERENCES CITED

U.S. PATENT DOCUMENTS

| | | | |
|---|---|---|---|
| 2026630 | 1933 | Harris | 30/29.5 |
| 2191073 | 1938 | Fishbein | 30/29.5 |
| 2243441 | 1939 | Russell | 30/43.6x |
| 2376197 | 1945 | Schlotthauer | 30/29.5 |
| 2801465 | 1957 | Cason | 30/29.5 |
| 2946121 | 1960 | Marach | 30/29.5 |
| 2987818 | 1961 | Rosenstein | 30/29.5x |
| 3007569 | 1961 | Babia | 206/56 |
| 3027635 | 1962 | Frith | 30/43.5 |
| 3054179 | 1962 | Reiser | 30/43.6 |
| 3381373 | 1968 | Brown | 30/29.5 |
| 3524253 | 1970 | Hoke | 30/29.5 |
| 3699652 | 1972 | Deverman | 30/29.5 |
| 3731379 | 1973 | Williams | 30/29.5 |
| 3925888 | 1975 | Bozsanyi | 30/29.5 |
| 4380121 | 1983 | Naimer | 30/42 |
| 4442596 | 1984 | Nasu | 30/41.5 |
| 4531287 | 1985 | Shibata | 30/43.6 |
| 4820277 | 1989 | Norelli | 604/192 |
| 4950249 | 1990 | Jagger | 604/192 |
| 4958432 | 1990 | Marshall | 30/29.5 |
| 5150808 | 1992 | Hamilton | 220/375 |
| 5193275 | 1993 | Hirokazu | 30/43 |
| 5423622 | 1995 | Perrotti | 401/59 |
| 5904431 | 1999 | Terruzzi | 401/59 |
| D243890 | 1977 | Yajama | D28/49 |
| D307491 | 1990 | Okada | D28/50 |
| D319711 | 1991 | Fujisawa | D28/44 |
| D341003 | 1993 | Maramatsu | D28/49 |
| D345822 | 1994 | Ullmann | D28/49 |

### BRIEF DESCRIPTION OF THE PRIOR ART

Containers related to the containment of the components of the preferred embodiment hair trimmer products with caps for the enclosure of the components such as blades, screens, batteries, electric motors and switches have been in the prior art for the last 100 years. However, these containers that include caps such as 5193275, 4531287, 4380121, 3524253, D243890, D307491, D319711, D341003 and D345822 have the problem of removable caps that can be fully separated from the container and misplaced.

Other containers of hair trimmer product components have no caps at all such as 2026630, 2191073, 2243441, 2376197, 2801465, 2946121, 2987818, 3027635, 3054179, 3381373, 3699652, 3731379, 3925888, 4442596 and 4958432.

U.S. Pat. No. 5,150,808 refers to a gas cap tether that stops the misplacement of an automotive gas tank cap while open, however this is not a split cap and handle combination that slides along the surface of a hand held container with the automatic activation and deactivation of the product function as it opens and closes.

U.S. Pat. No. 4,950,249 shows a split pivot open cap enclosure of a hypodermic needle, however this is not a split cap and handle combination that slides along the surface of a hand held container with the automatic activation and deactivation of the product function as it opens and closes.

None of the previous art illustrates a split cap and handle combination that slides along the surface of a container with the automatic activation and deactivation of the product function as it opens and closes.

### DESCRIPTION OF DRAWINGS

FIG. 1a is a closed front view of the preferred embodiment hair trimmer showing the closed aspect of the container split cap and handle combination.

FIG. 1b is an opened front view of the preferred embodiment hair trimmer showing the opened aspect of the container split cap and handle combination.

FIG. 2a is a closed section view through the longitudinal centerline of preferred embodiment hair trimmer of the present invention showing the closed aspect of the container split cap and handle combination.

FIG. 2b is a opened section view through the longitudinal centerline of preferred embodiment hair trimmer of the present invention showing the opened aspect of the container split cap and handle combination.

FIG. 3 is a perspective view of the present invention

FIG. 4 is a perspective view of the present invention in an application to perform the multifunctions of containing, exposing, activating, deactivating and protecting a pump dispenser.

FIG. 5 is a perspective view of the present invention in an application to perform the multifunctions of containing, exposing, activating, deactivating and protecting a knife blade container.

FIG. 6 is a perspective view of the present invention in an application to perform the multifunctions of containing, exposing, activating, deactivating and protecting a flashlight.

FIG. 7 is a perspective view of the present invention in an application to perform the multifunctions of containing, exposing, activating, deactivating and protecting a key holder.

FIG. 8 is a perspective view of the present invention in an application to perform the multifunctions of containing, exposing, activating, deactivating and protecting a radio, media player, recorder to play music.

FIG. 9 is a perspective view of the present invention in an application to perform the multifunctions of containing, exposing, activating, deactivating and protecting a computer or electronic device to display information.

FIG. 10 is a perspective view of the present invention in an application to perform the multifunctions of containing, exposing, activating, deactivating and protecting a telephone, internet, computer, radio, pager or electronic device to provide the function of communication.

FIG. 11 is a perspective view of the present invention in an application to perform the multifunctions of containing, exposing, activating, deactivating and protecting key pads, buttons, levers or switches related to the remote control of the function of other products.

### DESCRIPTION OF THE PREFERRED EMBODIMENT

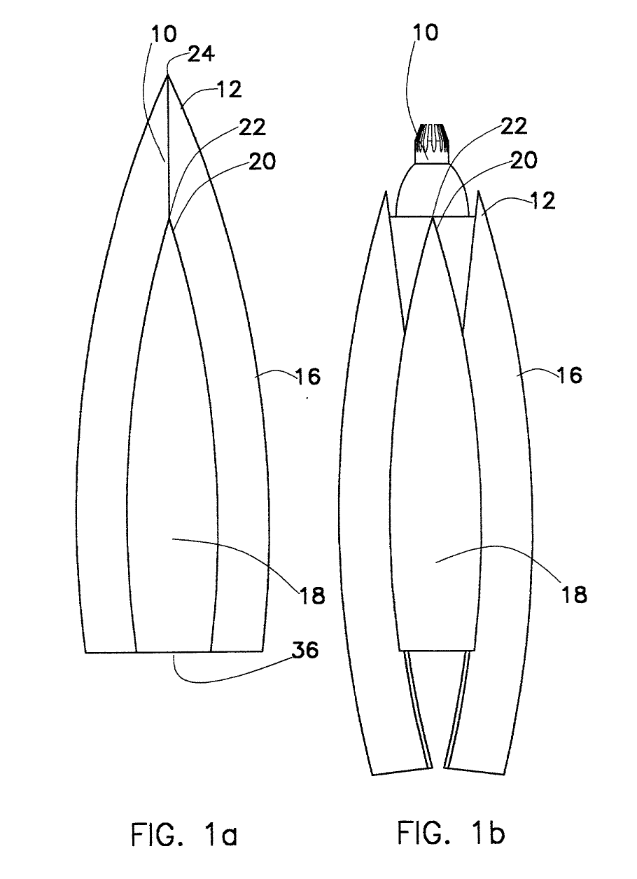

FIG. 1a is a closed front view of the preferred embodiment 10 product function hair trimmer application showing the 12 split cap and 16 handles which are slidably joined to the 18 container on 20 arched tracks which intersect at the 22 arched track intersection to form a 24 split cap seal when the 12 split cap and 16 handles are closed to the 22 track intersection. The 12 split cap and 16 handles align with the 36 product base on the bottom of the 18 container to automatically close the 18 container when the 36 product base on the bottom of the 18 container is placed on a surface.

FIG. 1b is an opened front view of the preferred embodiment 10 product function hair trimmer application showing the 12 split cap and 16 handles in an open position exposing the contents or the function of the contents of the 18 container. The 12 split cap and 16 handles slide open as a unit on the 20 arched tracks of the container exposing the preferred embodiment 10 hair trimmer product function.

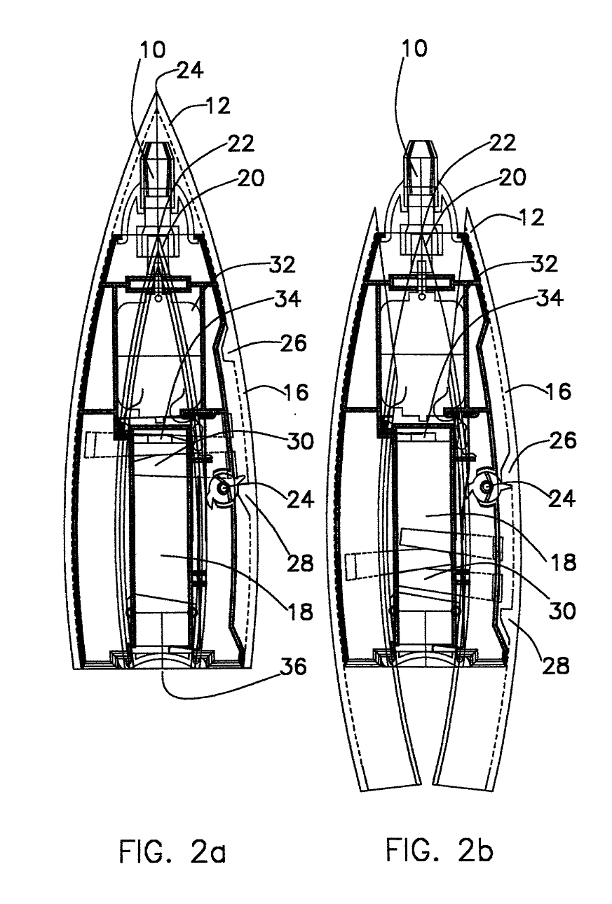

FIG. 2a is a closed section view through the longitudinal centerline of the preferred embodiment 10 product function hair trimmer application showing the 12 split cap and 16 handles which are slidably joined to the 18 container on 20 arched tracks which intersect at the 22 arched track intersection to form a 24 split cap seal when the 12 split cap and 16 handles are closed to the 22 track intersection. The 12 split cap and 16 handles align with the 36 product base on the bottom of the 18 container to automatically close the 18 container when the 36 product base on the bottom of the 18 container is placed on a surface.

FIG. 2b is a opened section view through the longitudinal centerline of the preferred embodiment 10 product function hair trimmer application showing the 12 split cap and 16 handles in an open position exposing the contents or the function of the contents of the 18 container. The 12 split cap and 16 handles slide open as a unit on the 20 arched tracks of the container exposing the preferred embodiment 10 hair trimmer product function. As the 12 split cap and 16 handles which are slidably joined to the 18 container on 20 arched tracks move from a closed to an open position, a 26 function activation tab activates the 24 switch causing an electrical circuit to be formed between the 32 motor and the 34 battery to automatically start the preferred embodiment 10 hair trimmer product function. The process reverses when the product is closed.

As the 12 split cap and 16 handles which are slidably joined to the 18 container on 20 arched tracks move from an open to a closed position, a 28 function deactivation tab deactivates the 24 switch causing an electrical circuit to be broken between the 32 motor and the 34 battery to automatically cease the preferred embodiment 10 hair trimmer product function.

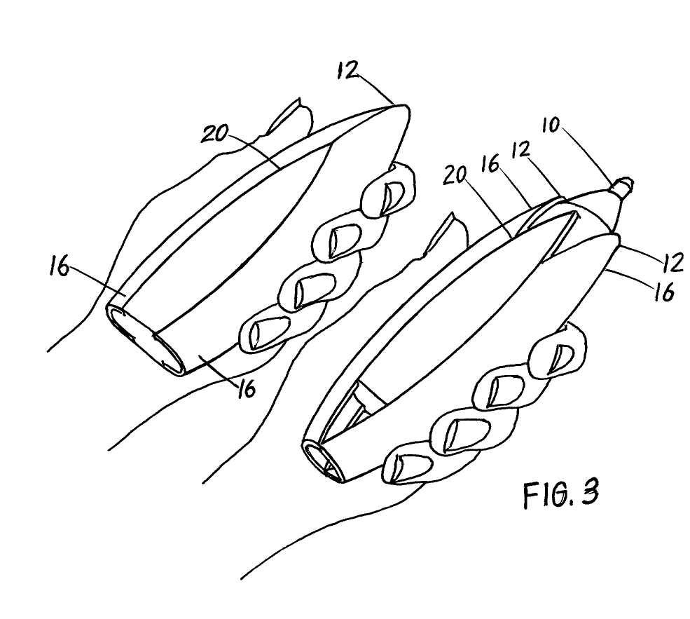

FIG. 3 is a perspective view of a closed and open condition of the present invention showing how the 12 split cap and 16 handles fit into the fingers and thumb of the human hand. Pressure on the 12 split cap and 16 handles near the base causes the product container to open, elongate, activates the 10 product function and provides a secure grip during use. Pressure on the 12 split cap and 16 handles near the closure causes the 12 split cap and 16 handles to slide closed along the 20 arched tracks which automatically deactivates the 10 product function, compacts the overall length for storage and causes the product container to close.

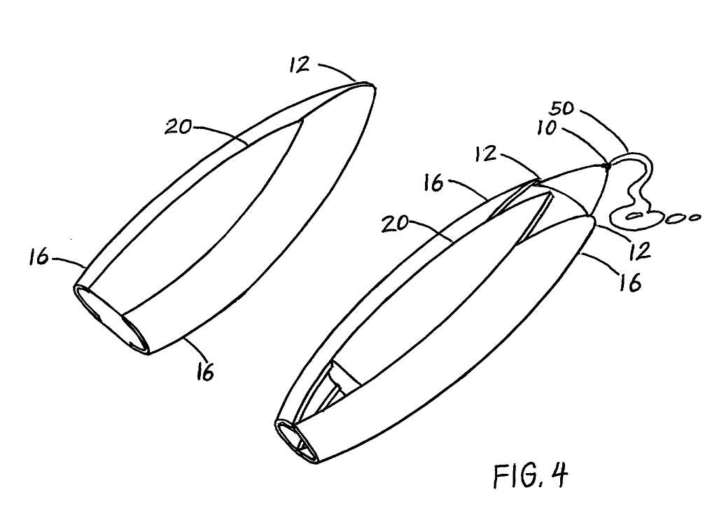

FIG. 4 is a perspective view of a closed and open condition of the present invention in a 10 product function 50 pump dispenser application to perform the multifunctions of containing, exposing, activating, deactivating, enclosing and protecting a pump dispenser by gripping and applying pressure to the 12 split cap and 16 handles to cause them to slide open as a unit on the 20 arched tracks of the container which contains the 10 product function. As the 12 split cap and 16 handles slide open, the 10 product function is exposed and the product is automatically activated. As the 12 split cap and 16 handles are gripped with applied pressure to cause them to slide closed as a unit on the 20 arched tracks the 10 product function is enclosed and the product is automatically deactivated.

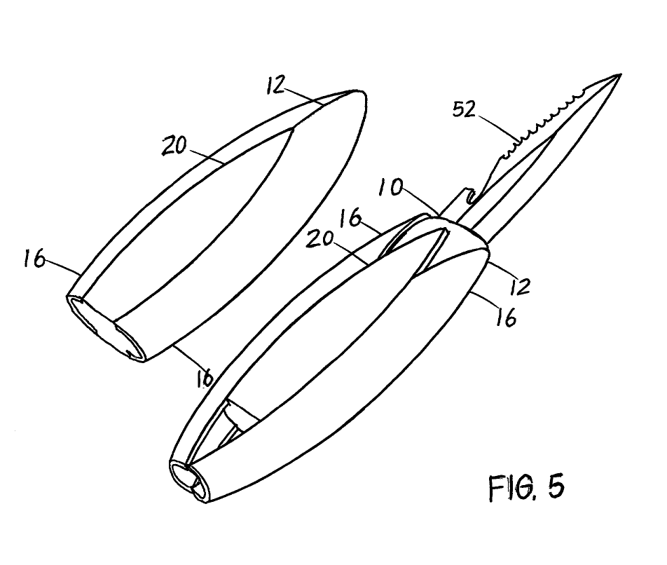

FIG. 5 is a perspective view of a closed and open condition of the present invention in a 10 product function 52 knife blade container application to perform the multifunctions of containing, exposing, activating, deactivating, enclosing and protecting a knife blade container by gripping and applying pressure to the 12 split cap and 16 handles to cause them to slide open as a unit on the 20 arched tracks of the container which contains the 10 product function. As the 12 split cap and 16 handles slide open, the 10 product function is exposed and the product is automatically activated. As the 12 split cap and 16 handles are gripped with applied pressure to cause them to slide closed as a unit on the 20 arched tracks the 10 product function is enclosed and the product is automatically deactivated.

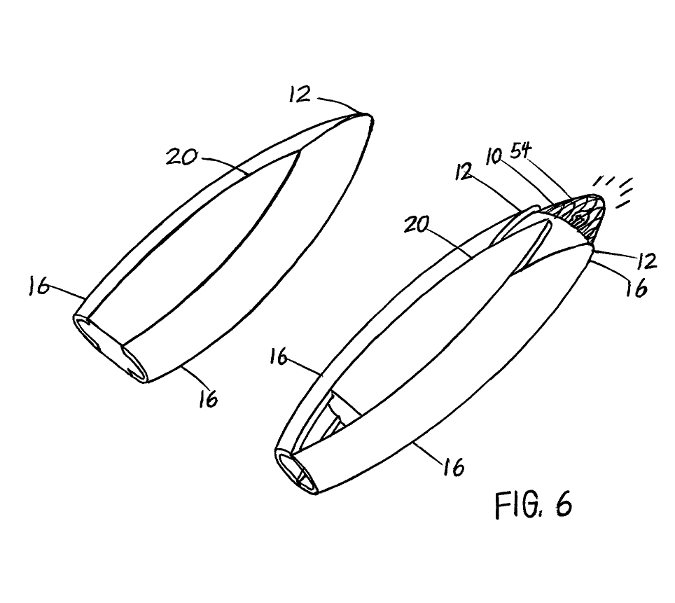

FIG. 6 is a perspective view of a closed and open condition of the present invention in a 10 product function 54 flashlight application to perform the multifunctions of containing, exposing, activating, deactivating, enclosing and protecting a flashlight by gripping and applying pressure to the 12 split cap and 16 handles to cause them to slide open as a unit on the 20 arched tracks of the container which contains the 10 product function. As the 12 split cap and 16 handles slide open, the 10 product function is exposed and the product is automatically activated. As the 12 split cap and 16 handles are gripped with applied pressure to cause them to slide closed as a unit on the 20 arched tracks the 10 product function is enclosed and the product is automatically deactivated.

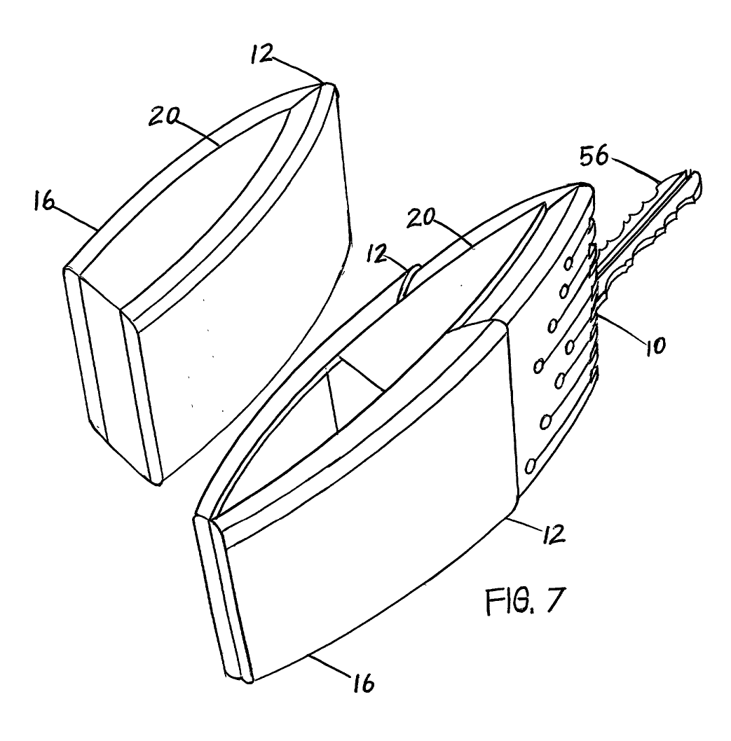

FIG. 7 is a perspective view of a closed and open condition of the present invention in a 10 product function 56 key holder application to perform the multifunctions of containing, exposing, activating, deactivating, enclosing and protecting a key holder by gripping and applying pressure to the 12 split cap and 16 handles to cause them to slide open as a unit on the 20 arched tracks of the container which contains the 10 product function. As the 12 split cap and 16 handles slide open, the 10 product function is exposed and the product is automatically activated. As the 12 split cap and 16 handles are gripped with applied pressure to cause them to slide closed as a unit on the 20 arched tracks the 10 product function is enclosed and the product is automatically deactivated.

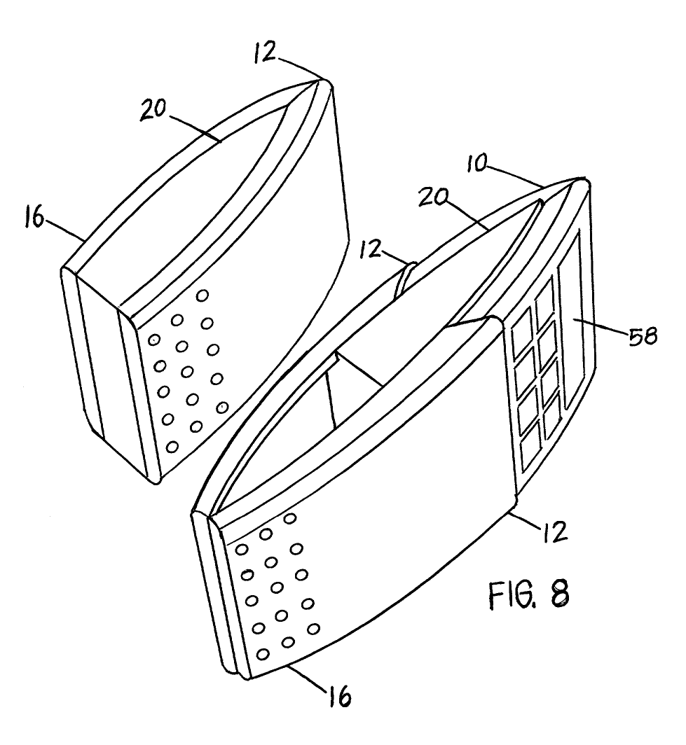

FIG. 8 is a perspective view of a closed and open condition of the present invention in a 10 product function 58 radio, media player, recorder to play music application to perform the multifunctions of containing, exposing, activating, deactivating, enclosing and protecting a radio, media player, recorder to play music by gripping and applying pressure to the 12 split cap and 16 handles to cause them to slide open as a unit on the 20 arched tracks of the container which contains the 10 product function. As the 12 split cap and 16 handles slide open, the 10 product function is exposed and the product is automatically activated. As the 12 split cap and 16 handles are gripped with applied pressure to cause them to slide closed as a unit on the 20 arched tracks the 10 product function is enclosed and the product is automatically deactivated.

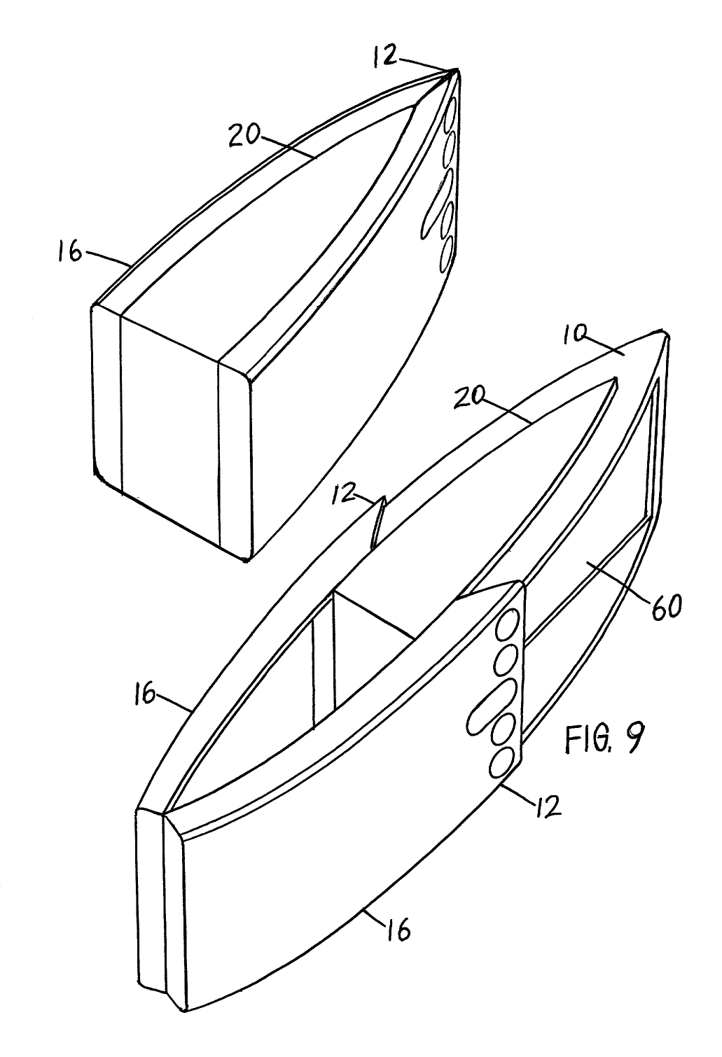

FIG. 9 is a perspective view of a closed and open condition of the present invention in a 10 product function 60 computer or electronic device to display information application to perform the multifunctions of containing, exposing, activating, deactivating, enclosing and protecting a computer or electronic device to display information by gripping and applying pressure to the 12 split cap and 16 handles to cause them to slide open as a unit on the 20 arched tracks of the container which contains the 10 product function. As the 12 split cap and 16 handles slide open, the 10 product function is exposed and the product is automatically activated. As the 12 split cap and 16 handles are gripped with applied pressure to cause them to slide closed as a unit on the 20 arched tracks the 10 product function is enclosed and the product is automatically deactivated.

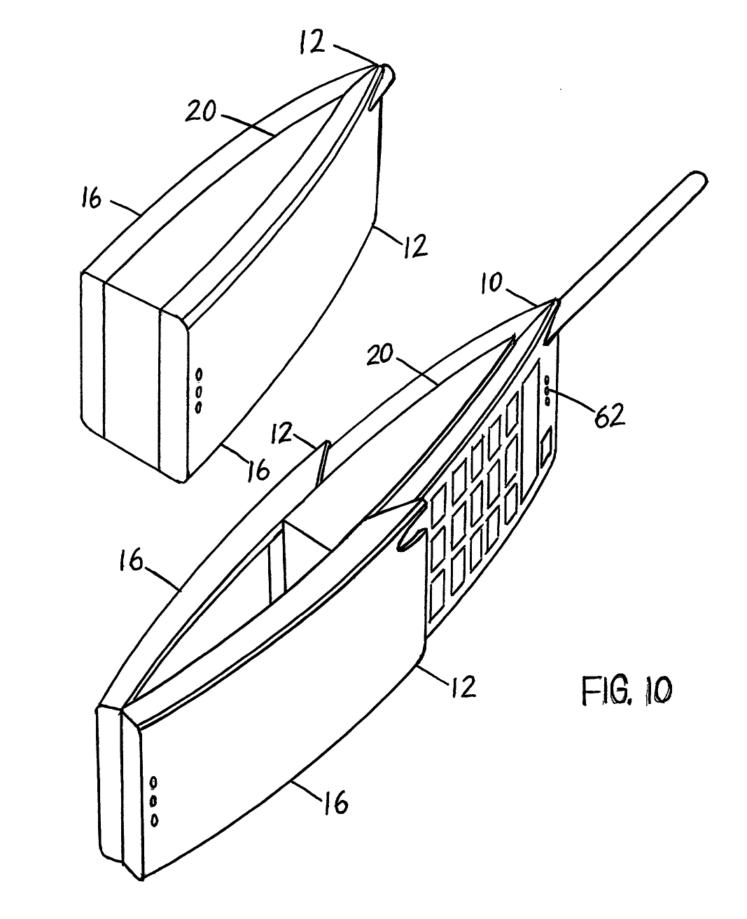

FIG. 10 is a perspective view of a closed and open condition of the present invention in a 10 product function 62 telephone, internet, computer, radio, pager or electronic communication application to perform the multifunctions of containing, exposing, activating, deactivating, enclosing and protecting a telephone, internet, computer, radio, pager or electronic device to provide the function of communication by gripping and applying pressure to the 12 split cap and 16 handles to cause them to slide open as a unit on the 20 arched tracks of the container which contains the 10 product function. As the 12 split cap and 16 handles slide open, the 10 product function is exposed and the product is automatically activated. As the 12 split cap and 16 handles are gripped with applied pressure to cause them to slide closed as a unit on the 20 arched tracks the 10 product function is enclosed and the product is automatically deactivated.

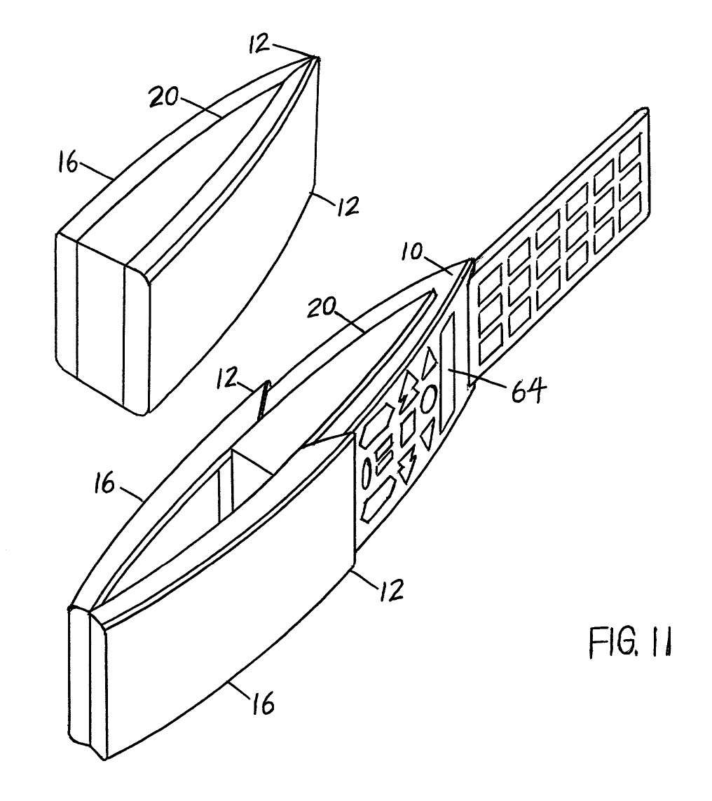

FIG. 11 is a perspective view of a closed and open condition of the present invention in a 10 product function 64 key pads, buttons, levers or switches related to the remote control of the function of other products application to perform the multifunctions of containing, exposing, activating, deactivating, enclosing and protecting key pads, buttons, levers or switches related to the remote control of the function of other products by gripping and applying pressure to the 12 split cap and 16 handles to cause them to slide open as a unit on the 20 arched tracks of the container which contains the 10 product function. As the 12 split cap and 16 handles slide open, the 10 product function is exposed and the product is automatically activated. As the 12 split cap and 16 handles are gripped with applied pressure to cause them to slide closed as a unit on the 20 arched tracks the 10 product function is enclosed and the product is automatically deactivated.

What is claimed is:

1. A container, cap and handle combination comprising:
A container with an inner volume and an outer surface having symmetrical or asymmetrical arched track pairs on opposite sides of the outer surface of the container extending from an intersection at the opening of the container to spread arched track pair ends on the flattened support base of the container connected to pair of half hollow, arching, combination split cap and handle components arched to match and slidably engage the symmetrical or asymmetrical arched track pairs on opposite sides of the container in order to form a product container.

2. The container of claim 1 wherein the cap and handle combination operate together when placed in the palm, fingers and thumb of a human hand to slidably open and close with alternating hand grip pressure on the base or the top of the combination split cap and handles which respectively opens and closes the container.

3. The container of claim 1 wherein the opening and closing of the combination split cap and handles automatically activates and deactivates the product functions of a variety of products that could be located inside this type of container.

4. The container of claim 1 wherein the combination split cap and handle are never separated from the container in its open, transitioning or closed positions so that the cap is never misplaced from the container.

5. The container of claim 1 wherein the product container is expanded and/or elongated when open for access to the product functions and is collapsed and/or shortened in size when closed for smaller transport and storage volume.

6. The container of claim 1 wherein the container and cap combination opens, activates, performs its function, deactivates and closes while gripped in one human hand without changing the hand grip position.

7. The container of claim 1 wherein the product placed in the palm of one hand and wrapped up in the fingers and thumb, performs the functions of opening, activating functions, deactivating and closing by alternating hand grip pressure on various portions of the product cap/handle combination.

8. The container of claim 1 wherein the product automatically closes, deactivates and reduces in size when placed upright on its flat support base.

9. The container of claim 1 wherein the combination container, split cap and handles protect or expose the functional aspects of products such as trimmers, keypads, pumps, blades, levers, lights, contacts, fans, connectors, appliances, motors, keys or other functional items with a minimum of hand movement.
